(19) United States
(12) Patent Application Publication
(10) Pub. No.: US 2026/0318381 A1
(43) Pub. Date: Oct. 15, 2026

(54) VEHICLE DYNAMIC DAMPER

(71) Applicant: Sumitomo Riko Company Limited, Aichi (JP)

(72) Inventors: YUSUKE SAKAGAMI, Aichi (JP); Kenichi Kato, Aichi (JP); YOSHIKI MORI, Aichi (JP); KOKUHO HIRANO, Aichi (JP)

(73) Assignee: Sumitomo Riko Company Limited, Aichi (JP)

(21) Appl. No.: 19/466,514

(22) Filed: Feb. 2, 2026

(30) Foreign Application Priority Data
Mar. 21, 2025 (JP) 2025-046706

(51) Int. Cl. F16F 7/108; B60J 5/10

(52) U.S. Cl. CPC F16F 7/108; B60J 5/10

(57) ABSTRACT

In a vehicle dynamic damper, a mass member and one set of mounting parts attached to a vibration-damping target member on two sides of the mass member are connected by one set of elastic bodies; the mounting part includes an adhesion plate part arranged to face the mass member and to which the elastic body is adhered, and a mounting plate part that protrudes from the adhesion plate part toward an opposite side from the mass member; a protruding tip portion of the mounting plate part serves as a fixing part having an overlapping surface that overlaps with the vibration-damping target member; and a separation plane separated from the vibration-damping target member is provided at a connection end portion of the mounting plate part with the adhesion plate part, and a biting part that defines an end portion of the elastic body is provided on the separation plane.

### CROSS-REFERENCE TO RELATED APPLICATION

This application claims the priority benefits of Japanese application no. 2025-046706, filed on Mar. 21, 2025. The entirety of the above-mentioned patent application is hereby incorporated by reference herein and made a part of this specification.

### BACKGROUND

### Technical Field

The disclosure relates to a vehicle dynamic damper that is attached to a vibration-damping target member of a vehicle.

### Related Art

Conventionally, there have been known vehicle dynamic dampers that are attached to vibration-damping target members such as vehicle backdoors, suspension members, and seats so as to suppress vibration. Vehicle dynamic dampers have a structure in which, for example, as disclosed in Japanese Patent Application Laid-Open Publication No. 2005-226699 (Patent Document 1), one set of mounting parts is provided on two sides of a mass member, and the mass member and the one set of mounting parts are respectively connected by elastic bodies. In response to vibration being input to the vibration-damping target member, the mass member is displaced in a resonance state, thereby consuming the vibration energy is consumed and reducing vibration of the vibration-damping target member.

### CITATION LIST

### Patent Document

[Patent Document 1] Japanese Patent Application Laid-Open Publication No. 2005-226699

One set of mounting parts of the vehicle dynamic damper has a fixing part that includes an overlapping surface that overlaps with the vibration-damping target member in a contact state, and it is necessary to prevent adhesion of flash of the elastic body to the overlapping surface of the fixing part. In the case of rubber flash adhering to the overlapping surface of the fixing part, the fixing strength of the mounting part to the vibration-damping target member may decrease due to sagging of the rubber flash over time, or the spring of the rubber flash may affect the vibration damping properties.

However, in the structure of Patent Document 1, the adhesion surface of the elastic body in the mounting part and the overlapping surface with the vibration-damping target member in the mounting part are close to each other, and there is a risk that flash of the elastic body could enter and adhere onto the overlapping surface with the vibration-damping target member. Particularly in automobiles, compactness of each member is important, and it is undesirable to leave a large space between the adhesion part of the elastic body in the mounting part and the overlapping surface with the vibration-damping target member in the dynamic damper. Therefore, achieving both the avoidance of rubber flash adhesion to the overlapping surface of the fixing part and compactness has been a major problem to be solved.

The problem to be solved by the disclosure is to provide a vehicle dynamic damper having a novel structure that can more reliably prevent flash of the elastic body from reaching the overlapping surface of the mounting part with the vibration-damping target member, thereby making it possible to achieve, for example, stability over time in the fixation of the mounting part to the vibration-damping target member and therefore stability over time of the vibration damping effect, while also achieving compactness.

Hereinafter, preferred aspects for understanding the disclosure will be described, but each aspect described below is described by way of example and may be adopted in appropriate combination with each other. Moreover, multiple constituent elements described in each aspect may be recognized and adopted independently to the extent possible, and may also be adopted in combination with any constituent element described in another aspect as appropriate. Thereby, the disclosure is not limited to the aspects described below, and various other aspects may be realized.

### SUMMARY

A first aspect is a vehicle dynamic damper, in which one set of mounting parts to be attached to a vibration-damping target member of a vehicle are arranged on two sides of a mass member, and the one set of mounting parts and the mass member are interconnected by one set of elastic bodies; the mounting part includes an adhesion plate part that is arranged to face the mass member and to which the elastic body is adhered, and a mounting plate part that protrudes from the adhesion plate part toward an opposite side from the mass member; a protruding tip portion of the mounting plate part from the adhesion plate part serves as a fixing part having an overlapping surface that overlaps with the vibration-damping target member in a contact state; and a separation plane that is separated in a thickness direction of the mounting plate part from the overlapping surface of the fixing part is provided at a connection end portion of the mounting plate part with the adhesion plate part, and a biting part that defines an end portion of the elastic body is provided on the separation plane.

### BRIEF DESCRIPTION OF THE DRAWINGS

FIG. 1 is a perspective view showing a vehicle dynamic damper as a first embodiment of the disclosure.

FIG. 2 is a plan view of the vehicle dynamic damper shown in FIG. 1.

FIG. 3is a rear view of the vehicle dynamic damper shown in FIG. 1.

FIG. 4 is a cross-sectional view taken along line IV-IV of FIG. 3.

FIG. 5 is a cross-sectional view showing a manufacturing step of the vehicle dynamic damper shown in FIG. 1, showing a state in which a mass member and one set of mounting parts are set in a molding die for the elastic body and mold clamping is performed.

### DESCRIPTION OF THE EMBODIMENTS

A first aspect is a vehicle dynamic damper, in which one set of mounting parts to be attached to a vibration-damping target member of a vehicle are arranged on two sides of a mass member, and the one set of mounting parts and the mass member are interconnected by one set of elastic bodies; the mounting part includes an adhesion plate part that is arranged to face the mass member and to which the elastic body is adhered, and a mounting plate part that protrudes from the adhesion plate part toward an opposite side from the mass member; a protruding tip portion of the mounting plate part from the adhesion plate part serves as a fixing part having an overlapping surface that overlaps with the vibration-damping target member in a contact state; and a separation plane that is separated in a thickness direction of the mounting plate part from the overlapping surface of the fixing part is provided at a connection end portion of the mounting plate part with the adhesion plate part, and a biting part that defines an end portion of the elastic body is provided on the separation plane.

According to the vehicle dynamic damper having the structure in accordance with this aspect, since a separation plane separated from the overlapping surface between the vibration-damping target member and the fixing part is provided, and a biting part that defines an end portion of the elastic body is provided on the separation plane, it is possible to prevent flash of the elastic body from extending to and adhering to the overlapping surface of the fixing part with the vibration-damping target member. Therefore, it is possible to prevent deterioration (sagging) over time of flash that has entered between the overlapping surface of the fixing part and the vibration-damping target member from affecting the fixing strength of the mounting part to the vibration-damping target member. As a result, stabilization of vibration damping performance is achieved, and problems such as abnormal noise due to rattling are also prevented. Moreover, since the biting part of the elastic body can be efficiently set, there is no need to significantly separate the elastic body from the overlapping surface to the vibration-damping target member, making it possible to achieve both stabilization of vibration damping performance over time and compactness of the dynamic damper, which were conventionally conflicting requirements.

Since the biting part is provided on the separation plane, a surface for strongly pressing the mold to prevent intrusion of flash of the elastic body during molding of the elastic body can be secured by the separation plane, and adhesion of flash to the fixing part can be prevented more reliably. Moreover, even if flash of the elastic body slightly enters from the biting part to the fixing part side, since the separation plane is positioned on the side farther from the vibration-damping target member than the fixing part, flash on the separation plane does not affect the fixing strength etc. to the vibration-damping target member, and stabilization of mounting of the mounting part to the vibration-damping target member is achieved.

A second aspect is the vehicle dynamic damper described in the first aspect, in which the separation plane is separated in a step-like manner with respect to the overlapping surface of the fixing part.

According to the vehicle dynamic damper having the structure in accordance with this aspect, by setting the step between the separation plane and the overlapping surface of the fixing part to a sufficient size, even if flash of the elastic body adheres to the separation plane, influence on fixing strength etc. by the flash can be prevented.

A third aspect is the vehicle dynamic damper described in the second aspect, in which the separation plane extends parallel to the overlapping surface of the fixing part.

According to the vehicle dynamic damper having the structure in accordance with this aspect, since the separation plane extends approximately parallel to the overlapping surface of the fixing part, it becomes easier to strongly press the mold against the separation plane during molding of the elastic body, and it is possible to prevent flash of the elastic body from extending beyond the biting part to the fixing part side.

A fourth aspect is the vehicle dynamic damper described in the second or third aspect, in which a separation distance of the separation plane with respect to the overlapping surface of the fixing part in the thickness direction of the mounting plate part is within a range of 0.5 mm to 2 mm.

According to the vehicle dynamic damper having the structure in accordance with this aspect, since the separation plane is separated by 0.5 mm or more to the side opposite to the vibration-damping target member with respect to the overlapping surface of the fixing part against the vibration-damping target member, even if flash of the elastic body is formed on the separation plane, it is possible to prevent the flash from affecting fixing of the mounting part to the vibration-damping target member.

Moreover, the separation plane has a separation distance of 2 mm or less from the overlapping surface of the fixing part against the vibration-damping target member to the side opposite to the vibration-damping target member in the thickness direction of the mounting plate part. This makes it possible to secure a wide adhesion surface of the elastic body at the adhesion part while preventing enlargement of the mounting part.

A fifth aspect is the vehicle dynamic damper described in any one of the second to fourth aspects, in which a length dimension of the separation plane in a protruding direction of the mounting plate part is 1.5 mm or more.

According to the vehicle dynamic damper having the structure in accordance with this aspect, since the length dimension of the separation plane is 1.5 mm or more, it becomes easy to provide the biting part on the separation plane, and by pressing the mold against the separation plane with a sufficiently wide area, it is possible to more reliably prevent flash from entering into the biting part.

According to the disclosure, in the vehicle dynamic damper, it is possible to more reliably prevent flash of the elastic body from reaching the overlapping surface with the vibration-damping target member in the mounting part, thereby making it possible to, for example, achieve both stability over time in the fixation of the mounting part to the vibration-damping target member and hence stability of the vibration damping effect over time as well as compactification.

Hereinafter, embodiments of the disclosure will be described with reference to the drawings.

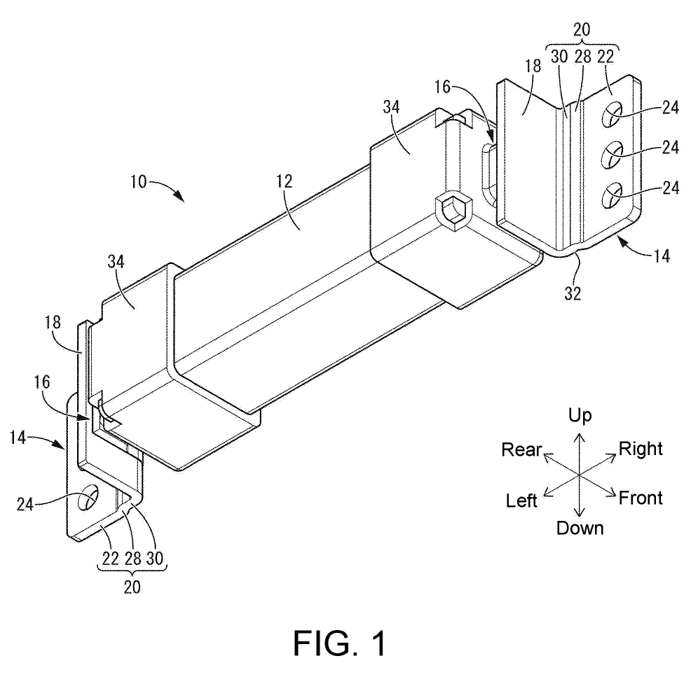

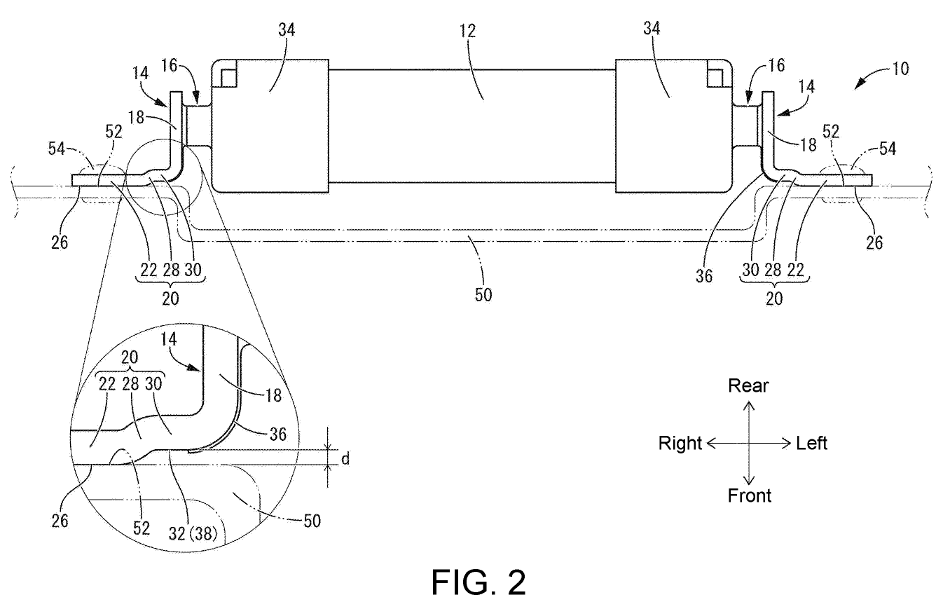

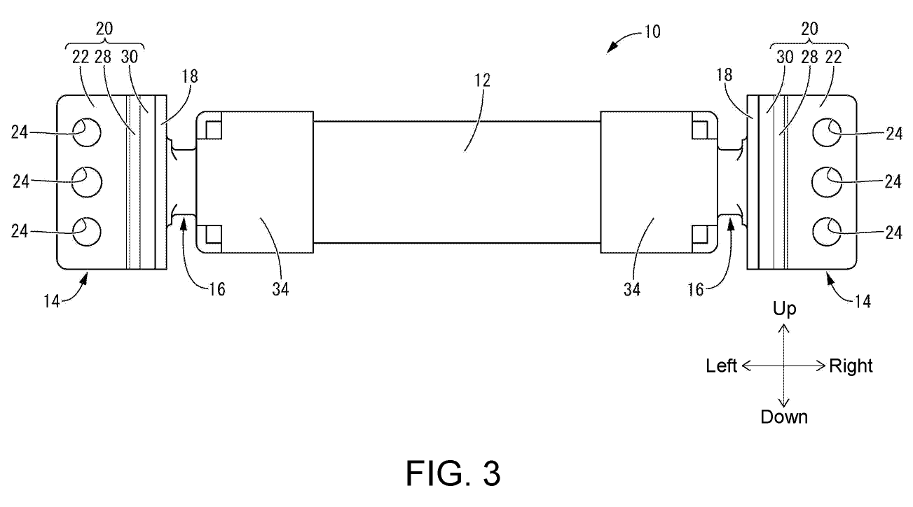

FIGS. 1-4 show a vehicle dynamic damper 10 as a first embodiment of the disclosure. The dynamic damper 10 has a structure in which one set of mounting parts 14, 14 arranged on the left and right sides of a mass member 12, and the mass member 12 and the one set of mounting parts 14, 14 are interconnected by one set of elastic bodies 16, 16. In the following description, as a general rule, the up-down direction refers to the up-down direction in FIG. 2 which shows the vehicle up-down direction in a vehicle mounted state attached to a backdoor 50 to be described later, the left-right direction refers to the left-right direction in FIG. 2 which shows the vehicle left-right direction in the vehicle mounted state, and the front-rear direction refers to the up-down direction in FIG. 2 which shows the vehicle front-rear direction in the vehicle mounted state.

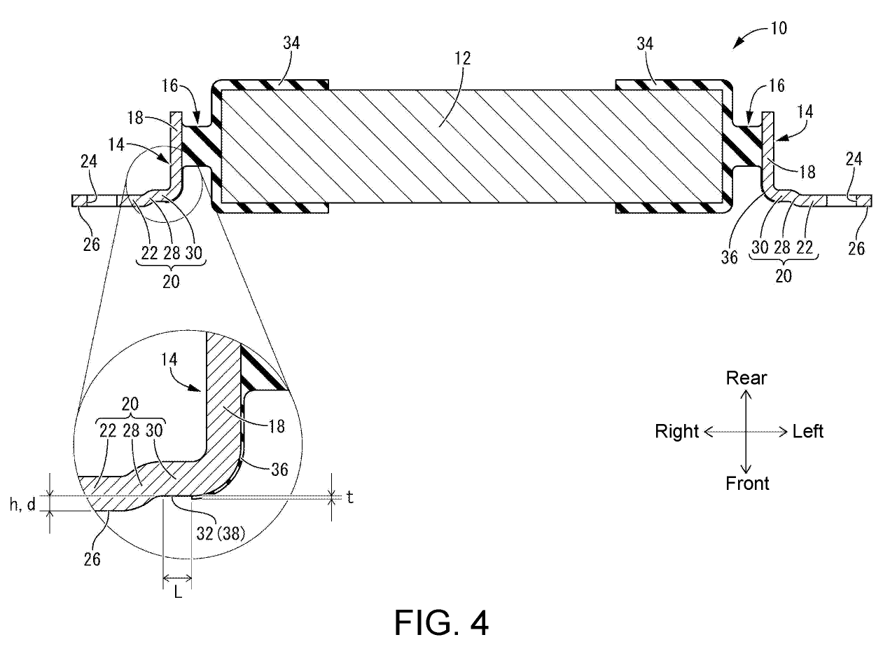

The mass member 12 has a rectangular block shape as shown in FIG. 4. The mass member 12 has a length in the left-right direction that is longer compared to the front-rear direction and the up-down direction, and has an approximately rectangular parallelepiped shape. The mass member 12 is preferably formed of a high specific gravity metal such as iron.

The one set of mounting parts 14, 14 are arranged separate from each other on the left and right sides of the mass member 12. The mounting part 14 integrally includes an adhesion plate part 18 that extends facing the left-right end surfaces of the mass member 12, and a mounting plate part 20 that protrudes from a front end of the adhesion plate part 18 perpendicularly to the adhesion plate part 18 toward the left-right outer side.

The adhesion plate part 18 has an approximately rectangular flat plate shape and extends approximately perpendicularly to the left-right direction. The adhesion plate part 18 is disposed on the left-right outer side with respect to the mass member 12, and faces the left-right end surfaces of the mass member 12 by a predetermined distance in the left-right direction. In the present embodiment, the left and right adhesion plate parts 18, 18 have approximately the same shape as each other, but may have shapes different from each other.

The mounting plate part 20 has an approximately rectangular flat plate shape and extends approximately perpendicularly to the front-rear direction. The mounting plate part 20 protrudes from a lower end portion of the adhesion plate part 18 toward the left-right outer side which is the opposite side from the mass member 12. In the present embodiment, the left and right mounting plate parts 20, 20 have approximately the same shape as each other, but may have shapes different from each other.

The mounting plate part 20 has a protruding tip portion (end portion on left-right outer side) from the adhesion plate part 18 that serves as a fixing part 22 fixed to a backdoor 50, which will be described later. The fixing part 22 is provided with three mounting holes 24, 24, 24 that penetrate in the front-rear direction which is the plate thickness direction, arranged in the up-down direction. The fixing part 22 has a front surface that serves as an overlapping surface 26 that overlaps with the backdoor 50, and is a plane that extends approximately perpendicularly to the front-rear direction. The fixing part 22 of the present embodiment has a flat plate shape that extends with approximately constant thickness, and both front and rear surfaces are planes that are approximately perpendicular to the front-rear direction.

As shown in FIGS. 2 and 4, the mounting plate part 20 has a step part 28 formed at an intermediate portion in the protruding direction from the adhesion plate part 18, and an end portion (protruding base end portion) on the adhesion plate part 18 side from the step part 28 serves as an escape part 30 that is positioned rearward from the fixing part 22. A front surface of the escape part 30 serves as a separation plane 32 that extends approximately perpendicularly to the front-rear direction. The separation plane 32 extends parallel to the overlapping surface 26 of the fixing part 22, and is positioned rearward of the overlapping surface 26 in a step-like manner. Moreover, the step part 28 and the escape part 30 in the mounting plate part 20 extend with an approximately constant cross-section in the up-down direction.

The separation plane 32 has a rearward separation distance d (see FIG. 2) with respect to the overlapping surface 26 of the fixing part 22 that is approximately the same as a height dimension h (see FIG. 4) of the step part 28. The rearward separation distance d of the separation plane 32 with respect to the overlapping surface 26 of the fixing part 22 is preferably within a range of 0.5 mm to 2.0 mm, and more preferably within a range of 0.7 mm to 1.5 mm. In the present embodiment, the rearward separation distance d of the separation plane 32 with respect to the overlapping surface 26 of the fixing part 22 is set to approximately 1 mm.

A left-right length dimension L of the separation plane 32 is desirably 1.5 mm or more. The left-right length dimension L of the separation plane 32 shown in FIG. 4 is preferably within a range of 1.5 mm to 4.0 mm, and more preferably within a range of 2.0 mm to 3.0 mm. This allows a biting protrusion part 46 of a molding die 40 described later to be pressed against the separation plane 32 over a sufficiently wide range to effectively obtain a biting part 38 to be described later, and also allows securing the left-right length dimension of the overlapping surface 26 of the fixing part 22 while preventing enlargement of the mounting part 14 in the left-right direction. Moreover, in the case of the left-right length dimension L being too large or the above-mentioned separation distance d being too small, there may be concerns about the risk of vibration of the escape part 30 that rises in a cantilevered state from the fixing part 22 fixed to the backdoor 50 and extends away from the surface of the backdoor 50, or interference with the backdoor 50, so setting within the above dimensional ranges is preferable.

The mounting part 14 of the present embodiment is configured as a press-formed metal part that integrally includes the adhesion plate part 18 and the mounting plate part 20. That is, the mounting part 14 is formed by punching a metal base plate into a predetermined shape by press work and then appropriately bending it. In the mounting part 14, a connection portion between the adhesion plate part 18 and the mounting plate part 20 is formed by bending work.

The one set of mounting parts 14, 14 is arranged on the left and right sides of the mass member 12 as shown in FIGS. 1-4, with the adhesion plate parts 18, 18 facing the left-right end surfaces of the mass member 12 with a predetermined distance therebetween. Moreover, the mass member 12 and the adhesion plate parts 18, 18 of the one set of mounting parts 14, 14 are interconnected by the one set of elastic bodies 16, 16, thereby configuring the dynamic damper 10.

The elastic body 16 extends in the left-right direction between the opposing surfaces of the mass member 12 and the adhesion plate part 18, with the left-right inner side end surface adhered to the left-right end surfaces of the mass member 12 and the left-right outer side end surface adhered to the left-right inner surfaces of the adhesion plate part 18. The elastic body 16 has an approximately rectangular cross-sectional shape in the direction perpendicular to the left and right, with an up-down height dimension being larger than a front-rear width dimension. The elastic body 16 has rubber-like elasticity and is formed of rubber or resin elastomer. The elastic body 16 may be adhered to the mass member 12 and the mounting parts 14, 14 after molding, but for example, by being molded as an integrally molded product including the mass member 12 and the mounting parts 14, 14, it is adhered to the mass member 12 and the mounting parts 14, 14 during molding.

The elastic body 16 deforms in a direction that brings the mass member 12 and the adhesion plate part 18 closer together due to thermal shrinkage after molding. In the present embodiment, since the mounting parts 14, 14 arranged on two sides of the mass member 12 are independent from each other, the mounting parts 14, 14 are respectively displaced toward the mass member 12, allowing contraction deformation of the elastic bodies 16, 16 in the left-right direction. Therefore, for example, compared to a case in which the mounting plate parts 20, 20 positioned on two sides of the mass member 12 are integrally configured as one member, tensile strain of the elastic bodies 16, 16 is reduced or eliminated, thereby improving the durability of the elastic bodies 16, 16.

The left-right end portions of the mass member 12 are covered by covering parts 34 that are integrally formed with the elastic body 16. The covering parts 34 cover approximately the entire surface of the left-right end portions of the mass member 12 and are adhered to the mass member 12. As shown in FIG. 2, the four rear corners of the mass member 12 are exposed without being covered by the covering parts 34, and the exposed portions of the mass member 12 may be supported by a rear die 42b described later during molding of the elastic body 16 and the covering parts 34.

A thin extension part 36 extending from the elastic body 16 is adhered to a connection portion between the adhesion plate part 18 and the mounting plate part 20 in the mounting part 14. The extension part 36 is adhered to a front end portion of the adhesion plate part 18 and a base end portion (left-right inner side portion) of the mounting plate part 20. The extension part 36 is provided on the left-right inner side with respect to the step part 28 in the mounting plate part 20, with the left-right direction outer end positioned on the separation plane 32. On the left-right outer side with respect to the extension part 36 in the separation plane 32, a biting part 38 is set that defines the end portion on left-right outer side of the elastic body 16 including the extension part 36 on the mounting plate part 20. In the present embodiment, no flash or the like adheres to the left-right outer side with respect to the biting part 38 in the mounting plate part 20.

By forming the biting part 38 in the separation plane 32, the elastic body 16 does not reach the fixing part 22 and is not adhered to the overlapping surface 26 of the fixing part 22. The extension part 36 has a thickness dimension t that is smaller than the height dimension h of the step part 28, and is positioned rearward with respect to the overlapping surface 26 of the fixing part 22. Moreover, the extension part 36 in the present embodiment extends to the end portion on left-right inner side of the separation plane 32, with approximately the entire separation plane 32 serving as the biting part 38.

The dynamic damper 10 has a mass-spring system in which the mass member 12 serves as a mass component and the elastic bodies 16, 16 serve as spring components by connecting the mass member 12 and the mounting parts 14, 14 with the elastic bodies 16, 16. The tuning frequency of the dynamic damper 10, which is the resonance frequency of the mass-spring system, is appropriately set according to the frequency of the vibration for damping target and is not particularly limited, but is set to, for example, a frequency equivalent to running booming noise of a backdoor 50 described later that occurs during high-speed driving of an automobile.

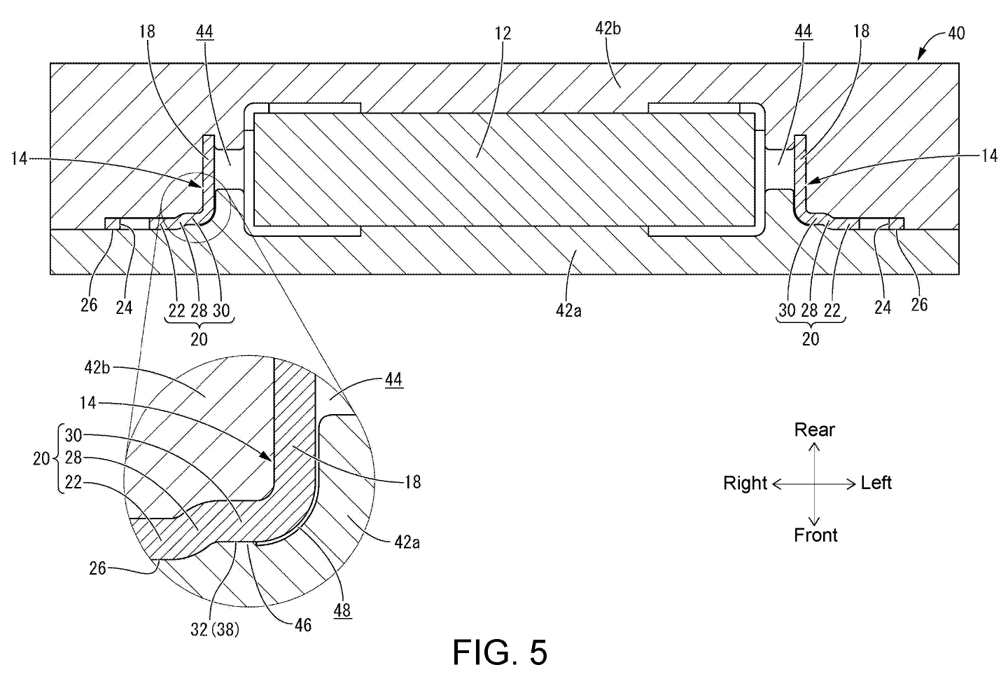

The dynamic damper 10 is manufactured by molding the elastic bodies 16, 16 using a molding die 40 as shown in FIG. 5. The molding die 40 includes a front die 42a and a rear die 42b. By performing mold clamping in a state where the front die 42a and the rear die 42b are overlapped with each other in the up-down direction, a cavity 44 is formed between the front die 42a and the rear die 42b. Between the front die 42a and the rear die 42b, the mass member 12 and the one set of mounting parts 14, 14 are set in a state where they are respectively arranged in the cavity 44. Elastic material is injected into the cavity 44, and the elastic body 16 integrally including the covering part 34 and the extension part 36 is molded as an integrally molded product including the mass member 12 and the mounting parts 14, 14, thereby manufacturing the dynamic damper 10.

As shown in an enlarged view in FIG. 5, the front die 42a is provided with a biting protrusion part 46 that is pressed against the separation plane 32 of the mounting part 14. The biting protrusion part 46 has a protruding tip surface that is a plane corresponds to a plane matching the separation plane 32, and in the mold clamping state shown in FIG. 5, strongly pressed against the separation plane 32 with surface contact. Accordingly, in the case of injecting rubber material into the cavity 44 for molding, entry of the rubber material between the separation plane 32 and the biting protrusion part 46 is prevented, and the contact portion between the separation plane 32 and the biting protrusion part 46 serves as the biting part 38. In the cavity 44 of the present embodiment, a narrow part 48, which is a molded portion of the extension part 36, extends to the left-right inner side of the biting protrusion part 46, and the left and right outer ends of the cavity 44 are defined by the biting protrusion parts 46, 46 on the left and right sides. Moreover, the narrow part 48 may be formed with the mounting part 14 and the front die 42a slightly separated, or may be formed by overlapping the mounting part 14 and the front die 42a in a manner that allows formation of flash.

The dynamic damper 10 having such a structure is attached to the backdoor 50 of an automobile, which is a vibration-damping target member, as shown in FIG. 2. That is, the overlapping surfaces 26, 26 of the fixing parts 22, 22 in the mounting parts 14, 14 are overlapped with mounting surfaces 52, 52 of the backdoor 50, and are caulked and fixed to the backdoor 50 by caulking pins 54 that are inserted through the respective mounting holes 24 of the fixing parts 22, 22. The fixing means for fixing the mounting part to the vibration-damping target member is not particularly limited, and may be, for example, fixing by bolts inserted through the mounting holes 24.

In the present embodiment, the surface of the portion of the backdoor 50 that faces the separation plane 32 is made substantially flush with the mounting surface 52 that is overlapped with the overlapping surface 26 of the fixing part 22. Accordingly, the separation plane 32 is positioned rearward of the mounting surface 52 and is separated from and faces the mounting surface 52 in the front-rear direction. The distance between the opposing surfaces of the separation plane 32 and the mounting surface 52 is approximately the same as the separation distance d between the separation plane 32 and the overlapping surface 26 of the fixing part 22 in the front-rear direction, and is preferably within a range of 0.5 mm to 2.0 mm. Accordingly, a portion of the elastic body 16 such as the extension part 36 or rubber flash is not sandwiched between the separation plane 32 and the mounting surface 52, and influence on vibration damping performance due to insertion of the elastic body 16 and destabilization of the mounting state are avoided.

In the fixing part 22 of the mounting part 14, adhesion of the elastic body 16 to the overlapping surface 26 is prevented by the biting part 38. Therefore, flash or the like of the elastic body 16 is not sandwiched between the overlapping surface of the overlapping surface 26 of the fixing part 22 and the mounting surface 52 of the backdoor 50, and problems such as rattling of the mounting part 14 against the backdoor 50 due to sagging of the flash are avoided. As a result, maintenance of the intended mounting state against the backdoor 50 and stabilization of vibration damping properties are achieved.

The mounting surface 52 of the backdoor 50 extends to the left-right inner side beyond the overlapping surface 26 of the fixing part 22 in the mounting part 14, and extends to the front of the escape part 30 in the mounting part 14. The front surface of the escape part 30 is a separation plane 32 positioned rearward of the overlapping surface 26 of the fixing part 22, with the separation plane 32 arranged to face the mounting surface 52 and being separated rearward. Accordingly, the extension part 36 of the elastic body 16 that extends to the separation plane 32 is separated rearward from the mounting surface 52 of the backdoor 50, and is prevented from being sandwiched and compressed between the opposing surfaces of the separation plane 32 and the mounting surface 52. Therefore, influence on vibration damping properties due to the spring action of the extension part 36 between the mounting part 14 and the backdoor 50, and influence on fixing strength due to sagging of the extension part 36 are avoided.

The embodiments of the disclosure have been described in detail above, but the disclosure is not limited by the specific descriptions thereof. For example, the separation plane does not need to be formed over the entire width direction (up-down direction) of the mounting part, and may be partially provided at portions corresponding to the adhesion portions of the elastic body. Moreover, the specific shapes and materials of the mass member and elastic body are not limited, and various shapes and materials may be selected according to the installation space and required properties. For example, in the aforementioned embodiment, the elastic body is arranged with its elastic center axis approximately perpendicular to the translational direction due to vibration for damping target of the mass member so as to undergo approximately shear deformation during displacement of the mass member. However, it is also possible to incline the elastic center axis of the elastic body with respect to the translational direction of the mass member so that compression-tension deformation occurs.

The separation plane does not necessarily need to be provided approximately parallel in a step-like manner with respect to the overlapping surface of the fixing part, and may be positioned on the opposite side from the vibration-damping target member with respect to the overlapping surface of the fixing part. Specifically, for example, the separation plane may be an inclined plane that inclines from the overlapping surface of the fixing part toward the adhesion part side (left-right direction inner side) to the opposite side from the vibration-damping target member. Moreover, the overlapping surface of the fixing part may be inclined with respect to the elastic main axis of the elastic body that elastically supports the mass member, and the shape of the fixing part may be appropriately set according to the mounting surface on the vehicle side. For example, even in the case where the fixing part 22 of the mounting part 14 is inclined with respect to the elastic support center axis of the dynamic damper 10 corresponding to the mounting surface on the vehicle side, it is desirable to form the escape part 30 (separation plane 32) parallel to the elastic support center axis, thereby making it possible to stably set the biting part 38 regardless of the shape of the mounting part 14.

The position of the biting part on the separation plane is not particularly limited as long as it is positioned on the separation plane. Moreover, the mold shown in the embodiment is illustrative and not limited thereto. For example, the mold portion (the portion including the biting protrusion part 46) that abuts against the separation plane 32 of the escape part 30 to form the biting part 38 in the front die 42a may be an independent mold component movable in the abutting direction. This makes it possible to more stably ensure sufficient abutting force of the biting protrusion part 46 against the separation plane 32 while allowing a certain degree of dimensional error between the molding die 40 and the mounting part 14.

The biting part is a portion that prevents rubber material from entering toward the fixing part side during molding of the elastic body, and it is not necessarily required that a portion of the elastic body reaches a position adjacent to the biting part. In short, the biting part may be set at a position separated from the molded portion of the elastic body and provided to prevent entry of unintentionally formed flash of the elastic body. Moreover, the disclosure addresses as one of its problems the prevention of flash of the elastic body from wrapping around to the overlapping surface of the mounting part with respect to the vibration-damping target member, and makes the aspect of the elastic body biting part on the overlapping surface of such mounting part one of its technical features. Therefore, for example, wrapping of the elastic body 16 around the protruding tip side or outer surface of the adhesion plate part 18 of the mounting part 14 in the embodiment does not fall under the above problem, and conventionally known elastic body biting structures may be appropriately adopted at such other portions.

A stopper for limiting the relative displacement amount between the mass member and the mounting part may also be provided. The stopper may be configured, for example, by providing a portion that contacts the mass member during large displacement on the mounting part.

The vibration-damping target member is not limited to the backdoor of a vehicle, and may be a constituent member of any part of the vehicle. Specifically, for example, the vibration-damping target member may be a suspension member or seat of the vehicle.

What is claimed is:

1. A vehicle dynamic damper,
wherein one set of mounting parts to be attached to a vibration-damping target member of a vehicle are arranged on two sides of a mass member;
the one set of mounting parts and the mass member are interconnected by one set of elastic bodies;
the mounting part comprises an adhesion plate part that is arranged to face the mass member and to which the elastic body is adhered, and a mounting plate part that protrudes from the adhesion plate part toward an opposite side from the mass member;
a protruding tip portion of the mounting plate part from the adhesion plate part serves as a fixing part having an overlapping surface that overlaps with the vibration-damping target member in a contact state; and
a separation plane that is separated in a thickness direction of the mounting plate part from the overlapping surface of the fixing part is provided at a connection end portion of the mounting plate part with the adhesion plate part, and a biting part that defines an end portion of the elastic body is provided on the separation plane.

2. The vehicle dynamic damper according to claim 1, wherein the separation plane is separated in a step-like manner with respect to the overlapping surface of the fixing part.

3. The vehicle dynamic damper according to claim 2, wherein the separation plane extends parallel to the overlapping surface of the fixing part.

4. The vehicle dynamic damper according to claim 2, wherein the separation plane has a separation distance with respect to the overlapping surface of the fixing part in the thickness direction of the mounting plate part within a range of 0.5 mm to 2 mm.

5. The vehicle dynamic damper according to claim 3, wherein the separation plane has a separation distance with respect to the overlapping surface of the fixing part in the thickness direction of the mounting plate part within a range of 0.5 mm to 2 mm.

6. The vehicle dynamic damper according to claim 2, wherein the separation plane has a length dimension in a protruding direction of the mounting plate part of 1.5 mm or more.

7. The vehicle dynamic damper according to claim 3, wherein the separation plane has a length dimension in a protruding direction of the mounting plate part of 1.5 mm or more.
